(19) United States
(12) Patent Application Publication
(10) Pub. No.: US 2007/0117936 A1
(43) Pub. Date: May 24, 2007

(54) Polymeric end-capping reagent for carbon dioxide-epoxide copolymers and a method for preparing the same

(75) Inventors: Tao Xiong, Changchun City (CN); Xiaojiang Zhao, Changchun City (CN); Xianhong Wang, Changchun City (CN); Fosong Wang, Changchun City (CN); Jiadong Min, Changchun City (CN); Qinghai Zhou, Changchun City (CN); Lijun Qiao, Changchun City (CN)

Correspondence Address: DICKSTEIN SHAPIRO LLP, 1177 AVENUE OF THE AMERICAS (6TH AVENUE), NEW YORK, NY, 10036-2714, US

(73) Assignee: CHANGCHUN INSTITUTE OF APPLIED CHEMISTRY CHINESE ACADEMY OF SCIENCE

(21) Appl. No.: 11/589,939

(22) Filed: Oct. 31, 2006

(30) Foreign Application Priority Data
Nov. 21, 2005 (CN) 2005/10017297.3

(51) Int. Cl. C08F 26/06

(52) U.S. Cl. 525/326.8; 525/330.3

(57) ABSTRACT

The invention relates to a polymeric end-capping reagent for carbon dioxide-epoxide copolymers and a method for producing the same. The polymeric end-capping reagents provided by the invention are maleic anhydride copolymers and maleic anhydride terpolymers. The polymeric end-capping reagent for carbon dioxide-propylene oxide copolymers of the invention is produced by a radical solution copolymerization method, and has a number average molecular weight of Mₙ=4-6×10⁴, a distribution index of 1.5-3.0. By using the polymeric end-capping reagent provided by the invention, the disadvantages of the small molecular end-capping reagent like volatilization during melting and precipitation on the melt surface during cooling, can be effectively overcome, moreover, the initial thermal decomposition temperatures of the carbon dioxide-propylene oxide copolymers end-capped with the polymeric end-capping reagents increase by about 30° C., as compared with that of the carbon dioxide-propylene oxide copolymer end-capped with “small molecular” maleic anhydride.

### TECHNICAL FIELD

The invention relates to a polymeric end-capping reagent for carbon dioxide-epoxide copolymers and a method for preparing the same.

### BACKGROUND ART

Carbon dioxide copolymers are biodegradable, and their mechanical properties are relatively good. However, they are inferior in thermal stability and liable to incur “unzipping” degradation. Dixon proposed an aliphatic polycarbonate end-capped by a hydroxyl reactive organic compound in a solution form (U.S. Pat. No. 4,066,630, U.S. Pat. No. 4,104,264, and U.S. Pat. No. 4,145,525). YANG Shuying et al. also pointed out that an aliphatic polycarbonate can obtain improved thermal stability after being end-capped with maleic anhydride, phenyl isocyanate, or toluene 2,4-diisocynate (Petrochemical Technology, 11(22), 730 to 734, 1993). As all the above-mentioned end-capping reagents belong to “small molecule” category, it is difficult to accurately control the end-capping temperature as well as the amount thereof being used during the melt reaction. Furthermore, the small molecular end-capping reagent is liable to volatilize, resulting in environment problem during the melt end-capping, and unreacted residue small molecular end-capping reagent is likely to precipitate on the melt surface during cooling process.

### DISCLOSURE OF THE INVENTION

An object of the invention is to provide a polymeric end-capping reagent for end-capping a carbon dioxide copolymer and a method for producing the same. With the polymeric end-capping reagent provided by the invention, not only the defects associated with small molecular end-capping reagent can be overcome effectively, but also the thermal stability of carbon dioxide copolymers can be improved to a great extent.

The invention comprises mainly the following aspects.

1. A polymeric end-capping reagent for carbon dioxide-epoxide copolymers, comprising a maleic anhydride copolymer.

2. The polymeric end-capping reagent for carbon dioxide-epoxide copolymers according to item 1, wherein the maleic anhydride copolymer is a maleic anhydride-second monomer copolymer and/or a maleic anhydride-second monomer-third monomer terpolymer.

3. The polymeric end-capping reagent for carbon dioxide-epoxide copolymers according to item 2, wherein the maleic anhydride copolymer is at least one selected from the group consisting of maleic anhydride-methyl methacrylate copolymer, maleic anhydride-methyl acrylate copolymer, maleic anhydride-n-butyl methacrylate copolymer, maleic anhydride-n-butyl acrylate copolymer; wherein the weight ratio of maleic anhydride to the second monomer is 5-25: 75-95.

4. The polymeric end-capping reagent for carbon dioxide-epoxide copolymers according to item 2, wherein the maleic anhydride terpolymer is at least one selected from the group consisting of maleic anhydride-n-butyl methacrylate-methyl methacrylate terpolymer, maleic anhydride-n-butyl methacrylate-methyl acrylate terpolymer, maleic anhydride-n-butyl acrylate-methyl methacrylate terpolymer, maleic anhydride-n-butyl acrylate-methyl acrylate terpolymer, maleic anhydride-isooctyl methacrylate-methyl methacrylate terpolymer, maleic anhydride-isooctyl methacrylate-methyl acrylate terpolymer, maleic anhydride-isooctyl acrylate-methyl methacrylate terpolymer, maleic anhydride-isooctyl acrylate-methyl acrylate terpolymer; wherein, the weight ratio of maleic anhydride to the second monomer to the third monomer is 2-6: 35-45: 49-63.

5. The polymeric end-capping reagent for carbon dioxide-epoxide copolymers according to item 3, wherein the weight ratio of maleic anhydride to the second monomer is 10-20: 80-90.

6. The polymeric end-capping reagent for carbon dioxide-epoxide copolymers according to item 4, wherein the weight ratio of maleic anhydride to the second monomer to the third monomer is 3-6: 3540: 54-62.

7. The polymeric end-capping reagent for carbon dioxide-epoxide copolymers according to item 1, having a number average molecular weight of Mₙ=4-6×10⁴, and a distribution index of 1.5-3.0.

8. A method for preparing a polymeric end-capping reagent for carbon dioxide-epoxide copolymers, comprising the steps of:

copolymerizing maleic anhydride and other comonomer(s) in a solvent by using an initiator; and

post-processing the resultant maleic anhydride copolymer to obtain the polymeric end-capping reagent for carbon dioxide-epoxide copolymers.

9. The method according to item 8, wherein the initiator is at least one selected from the group consisting of benzoyl peroxide, lauroyl peroxide, and azobisisobutyronitrile.

10. The method according to item 8, wherein the other comonomer is one monomer selected from the group consisting of methyl methacrylate, methyl acrylate, n-butyl methacrylate, and n-butyl acrylate, which is a second monomer being copolymerized with maleic anhydride to produce maleic anhydride—the second monomer copolymer, wherein the weight ratio of maleic anhydride to the second monomer is 5-25: 75-95.

11. The method according to item 8, wherein the other comonomers are two different monomers selected from the group consisting of methyl methacrylate, methyl acrylate, n-butyl methacrylate, n-butyl acrylate, isooctyl methacrylate, and isooctyl acrylate, wherein the two different monomers are a second monomer and a third monomer being copolymerized with maleic anhydride to produce maleic anhydride—the second monomer—the third monomer terpolymer, respectively, wherein the weight ratio of maleic anhydride to the second monomer to the third monomer is 2-6: 35-45: 49-63.

12. The method according to item 10, wherein the weight ratio of maleic anhydride and the second monomer is 10-20: 80-90.

13. The method according to item 11, wherein the weight ratio of maleic anhydride to the second monomer to the third monomer is 3-6: 35-40: 54-62.

14. The method according to item 8, wherein the initiator is used in an amount of 1% to 1% by weight based on the total weight of the monomers.

15. The method according to item 8, wherein the initiator is used in an amount of 3% to 6% by weight based on the total weight of the monomers.

16. The method according to item 8, wherein the solvent is anhydrous toluene.

17. The method according to item 8, wherein the post-processing includes:

distilling the reaction mixture under a reduced pressure at a temperature of 100 to 120° C. until no distillate drops out, and

transferring the reaction mixture into a vacuum oven and drying till a constant weight, thus obtaining the polymeric end-capping reagent.

### BRIEF DESCRIPTION OF THE DRAWINGS

FIG. 1 is a thermal decomposition diagram of a carbon dioxide-propylene oxide copolymer end-capped with the polymeric end-capping reagent produced in Example 3.

FIG. 2 is a thermal decomposition diagram of a carbon dioxide-propylene oxide copolymer end-capped with the polymeric end-capping reagent produced in Example 5.

FIG. 3 is a thermal decomposition diagram of a carbon dioxide-propylene oxide copolymer end-capped with the polymeric end-capping reagent produced in Example 1.

FIG. 4 is a thermal decomposition diagram of a carbon dioxide-propylene oxide copolymer end-capped with maleic anhydride, a small molecular end-capping reagent.

### DETAILED DESCRIPTION OF THE PREFERRED EMBODIMENTS

1. The Polymeric End-Capping Reagent of the Invention:

The polymeric end-capping reagent of the invention includes:

a maleic anhydride copolymer, (hereinafter referred to a maleic anhydride-second monomer copolymer) such as maleic anhydride-methyl methacrylate, maleic anhydride-methyl acrylate, maleic anhydride-n-butyl methacrylate, and maleic anhydride-n-butyl acrylate binary random copolymer, wherein the weight ratio of maleic anhydride to the second monomer is 5-25: 75-95, and preferably 10-20: 80-90; and

a maleic anhydride terpolymer (hereinafter referred to a maleic anhydride-second monomer-third monomer copolymer) such as maleic anhydride-n-butyl methacrylate-methyl methacrylate, maleic anhydride-n-butyl methacrylate-methyl acrylate, maleic anhydride-n-butyl acrylate-methyl methacrylate, maleic anhydride-n-butyl acrylate-methyl acrylate, maleic anhydride-isooctyl methacrylate-methyl methacrylate, maleic anhydride-isooctyl methacrylate-methyl acrylate, maleic anhydride-isooctyl acrylate-methyl methacrylate, and maleic anhydride-isooctyl acrylate-methyl acrylate terpolymer, wherein the weight ratio of maleic anhydride to the second monomer to the third monomer is 2-6: 35-45: 49-63, and preferably 3-6: 35-40: 54-62.

2. A Method for Preparing the Polymeric End-Capping Reagent

Under a nitrogen atmosphere, a calculated amount of purified maleic anhydride and 45% by weight of anhydrous toluene based on the total weight of the reaction mixture are added into a three-necked flask equipped with a constant pressure dropping funnel after the flask is purged with nitrogen gas. When the inner temperature of the flask maintains constantly at a temperature of 85 to 90° C., an other monomer containing 1% to 1%, and preferably 3% to 6% of initiator based on the total weight of the monomers in the case of copolymer, or a mixture of two other monomers containing 1% to 1%, and preferably 3% to 6% of initiator based on the total weight of the monomers in the case of terpolymer is added dropwise through the constant pressure dropping funnel into the flask with vigorous stirring, over a time period of 30 to 60 min. Polymerization is carried out at 85 to 90° C. for 7 to 10 hours. Thereafter the reaction mixture is subjected to distillation under a reduced pressure at 100 to 120° C. until no distillate drops out, then the residue reactant is removed by a vacuum oven and dried at 120° C. till a constant weight, thus a polymeric end-capping reagent is obtained. The polymeric end-capping reagent has a yield of 80 to 95%, a number average molecular weight (Mₙ) of 4 to 6×10⁴, and a distribution index of 1.5 to 3.0.

The initiator for preparing the maleic anhydride copolymer and terpolymer is one of benzoyl peroxide, lauroyl peroxide, and azobisisobutyronitrile. The initiator is used in an amount of 1% to 1%, and preferably 3% to 6% based on the total weight of the monomers.

The carbon dioxide copolymer used in the invention is a carbon dioxide-propylene oxide copolymer.

The polymeric end-capping reagent of the invention is used for end-capping the carbon dioxide copolymer. The details of the method are as follows. Into 80 to 90 parts by weight of the carbon dioxide-epoxide copolymer, 10 to 20 parts by weight of the polymeric end-capping reagent are added, and mixed uniformly in a high speed blender. The mixture is dried in a vacuum oven at a temperature of 40° C. for 10 hours, and then placed into a Haake mixer, and banbury mixed with a speed of 25 to 40 r/min at a temperature of 140 to 160° C. for 2.5 to 5 min. The mixture can be used for thermal press molding or blow molding.

The polymeric end-capping reagent for end-capping carbon dioxide copolymers produced by the method of the invention can not only overcome effectively the disadvantage of a small molecular end-capping reagent that is liable to volatilize during melting and evolve at the melt surface during cooling, but also greatly improve the thermal stability of carbon dioxide copolymers. The initial thermal decomposition temperatures of the carbon dioxide-propylene oxide copolymers end-capped with the polymeric end-capping reagents increase by 28.17° C. to 33.48° C., as compared with that of the carbon dioxide-propylene oxide copolymer end-capped with “small molecular” maleic anhydride.

### EXAMPLE 1

A 250 mL three-necked flask equipped with a constant pressure dropping funnel was vacuumed, and purged with nitrogen gas. Then 1.84 g of purified maleic anhydride and 15.4 g of anhydrous toluene were put into the flask under a nitrogen atmosphere. As the inner temperature of the flask was kept at 85° C., under a vigorous stirring, a solution of methyl methacrylate (16.92 g) containing 0.094 g of benzoyl peroxide was added dropwise through the constant pressure dropping funnel over 30 min. Copolymerization was carried out at 85° C. for 7 hours. After the reaction was completed, the reaction mixture was distilled under a reduced pressure at 110° C. until no distillate dropped out. Then the reaction mixture was transferred into a vacuum oven and dried at 120° C. till a constant weight. Thus, 15.8 g of a white copolymer end-capping reagent having a Mₙ of 43,000 and a distribution index of 1.8 was obtained.

### EXAMPLE 2

A 250 mL three-necked flask equipped with a constant pressure dropping funnel was vacuumed, and purged with nitrogen gas. Then 4.90 g of purified maleic anhydride and 25.10 g of anhydrous toluene were put into the flask under a nitrogen atmosphere. When the inner temperature of the flask was kept at 85° C., under a vigorous stirring, a solution of n-butyl acrylate (25.63 g) containing 0.153 g of benzoyl peroxide was added dropwise through the constant pressure dropping funnel over 40 min. Copolymerization was carried out at 85° C. for 8 hours. After the reaction was completed, the reaction mixture was distilled under a reduced pressure at 120° C. until no distillate dropped out. Thereafter, the reaction mixture was transferred into a vacuum oven and dried at 120° C. till a constant weight. Thus, 28.9 g of a white copolymer end-capping reagent having a Mₙ of 41,000 and a distribution index of 2.3 was obtained.

### EXAMPLE 3

A 250 mL three-necked flask equipped with a constant pressure dropping funnel was vacuumed, and purged with nitrogen gas. Then 1.54 g of purified maleic anhydride and 28.1 g of anhydrous toluene were put into the flask under a nitrogen atmosphere. When the inner temperature of the flask was kept at 90° C., under a vigorous stirring, a mixed solution of n-butyl methacrylate (8.96 g) and methyl methacrylate (23.69 g) containing 0.171 g of benzoyl peroxide was added dropwise through the constant pressure dropping funnel over 60 min. The terpolymerization was carried out at 90° C. for 7.5 hours. After the reaction was completed, the reaction mixture was distilled under a reduced pressure at 120° C. until no distillate dropped out. Thereafter, the reaction mixture was transferred into a vacuum oven and dried at 120° C. till a constant weight. Thus, 27.7 g of a white terpolymer end-capping reagent having a Mₙ of 51,000 and a distribution index of 2.5 was obtained.

### EXAMPLE 4

A 250 mL three-necked flask equipped with a constant pressure dropping funnel was vacuumed, and purged with nitrogen gas. Then 1.03 g of purified maleic anhydride and 19.4 g of anhydrous toluene were put into the flask under a nitrogen atmosphere. When the temperature of the mixture inside the flask was kept at 85° C., under a vigorous stirring, a mixed solution of n-butyl methacrylate (8.96 g) and methyl methacrylate (13.63 g) containing 0.118 g of benzoyl peroxide was added dropwise through the constant pressure dropping funnel over 50 min. The terpolymerization was carried out at 85° C. for 10 hours. After the reaction was completed, the reaction mixture was distilled under a reduced pressure at 120° C. until no distillate dropped out. Thereafter, the reaction mixture was transferred into a vacuum oven and dried at 120° C. till a constant weight. Thus, 19.4 g of a white terpolymer end-capping reagent having a Mₙ of 59,000 and a distribution index of 1.9 was obtained.

### EXAMPLE 5

A 250 mL three-necked flask equipped with a constant pressure dropping funnel was vacuumed, and purged with nitrogen gas. Then 1.20 g of purified maleic anhydride and 21.3 g of anhydrous toluene were put into the flask under a nitrogen atmosphere. When the temperature of the mixture inside the flask was kept at 85° C., under a vigorous stirring, a mixed solution of n-butyl acrylate (6.27 g) and methyl methacrylate (18.42 g) containing 0.129 g of benzoyl peroxide was added dropwise through the constant pressure dropping funnel over 60 min. The terpolymerization was carried out at 85° C. for 8 hours. After the reaction was completed, the reaction mixture was distilled under a reduced pressure at 110° C. until no distillate dropped out. Thereafter, the reaction mixture was transferred into a vacuum oven and dried at 120° C. till a constant weight. Thus, 22.0 g of a white terpolymer end-capping reagent having a Mₙ of 48,000 and a distribution index of 2.4 was obtained.

### EXAMPLE 6

A 250 mL three-necked flask equipped with a constant pressure dropping funnel was vacuumed, and purged with nitrogen gas. Then 1.09 g of purified maleic anhydride and 23.22 g of anhydrous toluene were put into the flask under a nitrogen atmosphere. When the inner temperature of the flask was kept at 90° C., under a vigorous stirring, a mixed solution of isooctyl methacrylate (13.28 g) and methyl methacrylate (14.48 g) containing 0.144 g of lauroyl peroxide was added dropwise through the constant pressure dropping funnel over 60 min. The terpolymerization was carried out at 90° C. for 9 hours. After the reaction was completed, the reaction mixture was distilled under a reduced pressure at 110° C. until no distillate dropped out. Thereafter the reaction mixture was transferred into a vacuum oven and dried at 120° C. till a constant weight. Thus, 23.1 g of a white ternary polymeric end-capping reagent having a Mₙ Of 56,000 and a distribution index of 2.3 was obtained.

### EXAMPLE 7

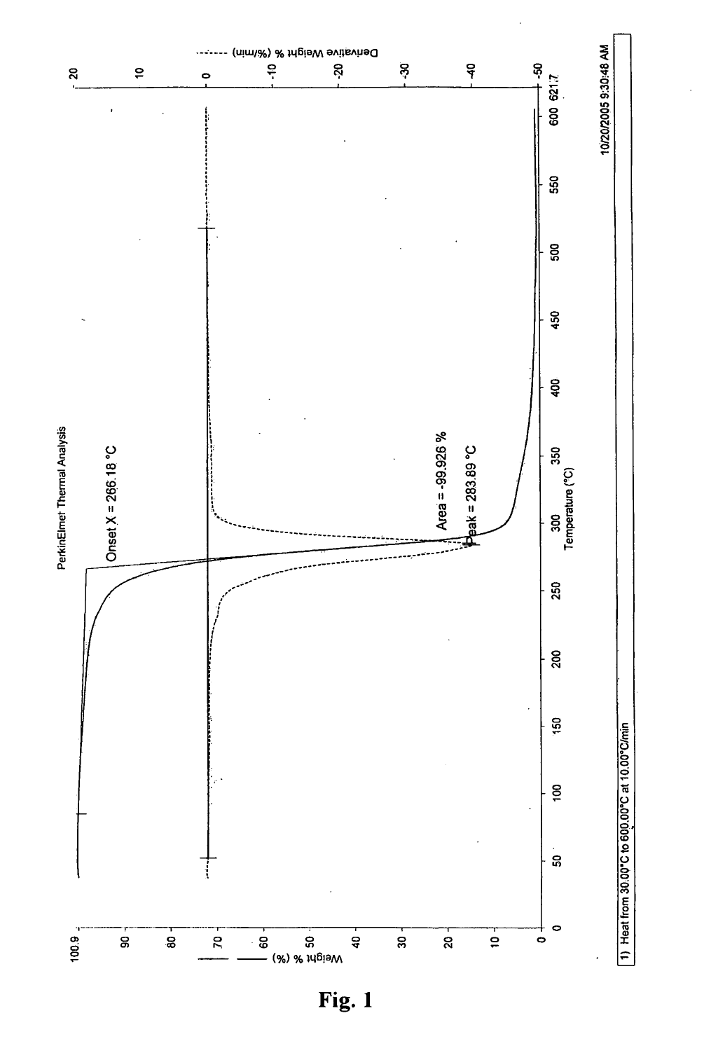

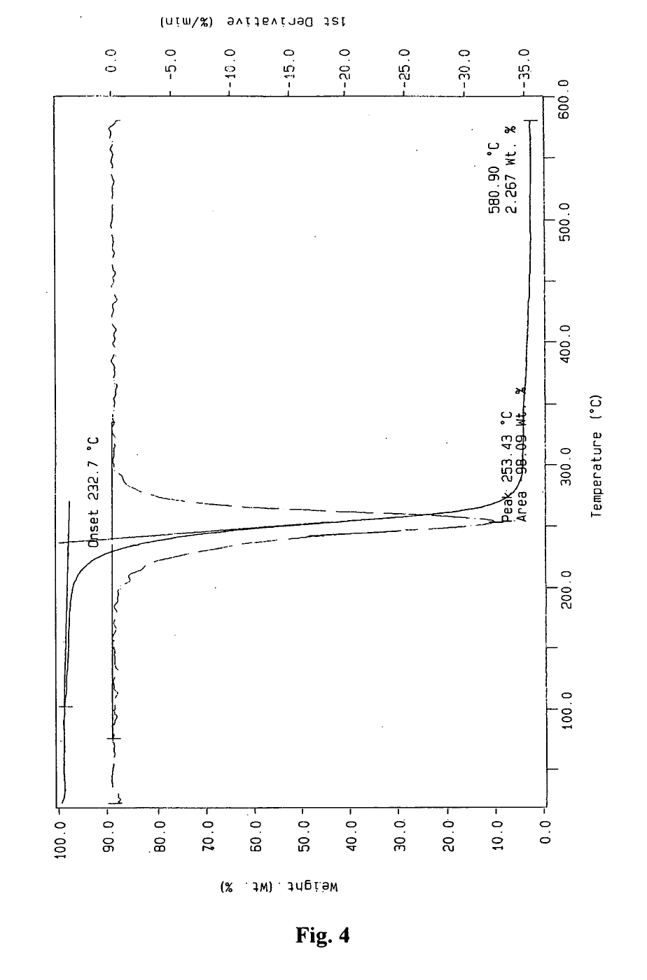

85 g of a carbon dioxide-propylene oxide copolymer having a number average molecular weight of 67,000 (produced according to CN 1116332C and Chinese patent application No. 03105023.9) and 15 g of the polymeric end-capping reagent (produced in Example 3) were mixed uniformly in a high speed blender. The mixture was dried in a vacuum oven at 40° C. for 10 hours, and then put into a Haake mixer, and banbury mixed with a speed of 30 r/min at 140° C. for 3 min. The mixture was taken out, cut into pieces, and cooled. The initial thermal decomposition temperature was 266° C. (see, FIG. 1), which was higher than that of the carbon dioxide-propylene oxide copolymer end-capped with maleic anhydride (a small molecular end-capping reagent) (232° C., see, FIG. 4). The analysis instrument used was PerkinElmer Thermal Analyzer.

### EXAMPLE 8

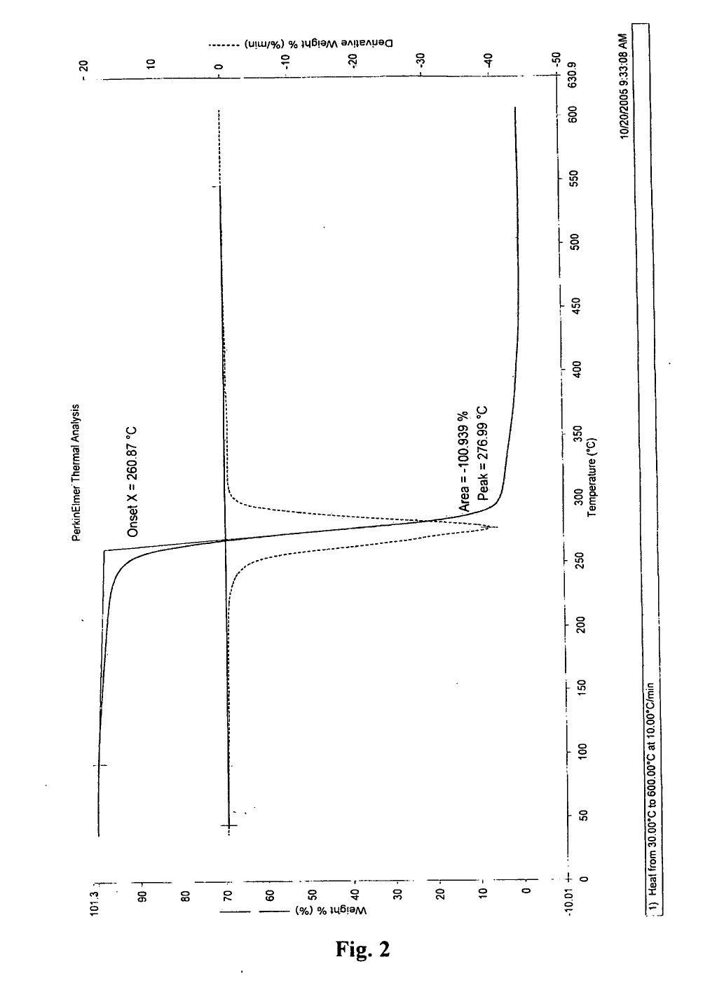

90 g of a carbon dioxide-propylene oxide copolymer having a number average molecular weight of 82,000 (produced according to CN 1116332C and Chinese patent application No. 03105023.9) and 10 g of the polymeric end-capping reagent (produced in Example 5) were mixed uniformly in a high speed blender. The mixture was dried in a vacuum oven at 40° C. for 10 hours, and then put into a Haake mixer, and banbury mixed with a speed of 35 r/min at 150° C. for 3.5 min. The mixture was taken out, cut into pieces, and cooled. The initial thermal decomposition temperature was about 261° C. (see, FIG. 2), which was higher than that of the carbon dioxide-propylene oxide copolymer end-capped with maleic anhydride (232° C., see, FIG. 4). The analysis instrument used was PerkinElmer Thermal Analyzer.

### EXAMPLE 9

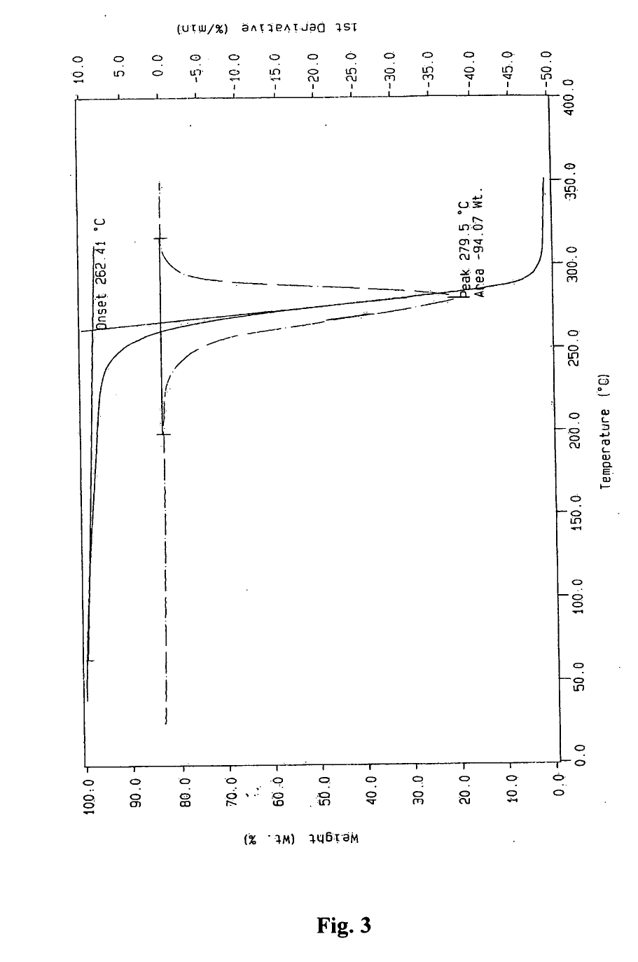

85 g of a carbon dioxide-propylene oxide copolymer having a number average molecular weight of 82,000 (produced according to CN 1116332C and Chinese patent application No. 03105023.9) and 15 g of the polymeric end-capping reagent (produced in Example 1) was added, and mixed uniformly in a high speed blender. The mixture was dried in a vacuum oven at 40° C. for 10 hours, then put into a Haake mixer, and banbury mixed with a speed of 35 r/min at 145° C. for 3.5 min. The mixture was taken out, cut into pieces, and cooled. The initial thermal decomposition temperature was 262° C. (see, FIG. 3), which was higher than that of the carbon dioxide-propylene oxide copolymer end-capped with maleic anhydride (232° C., see, FIG. 4). The analysis instrument used was PerkinElmer Thermal Analyzer.

### COMPARATIVE EXAMPLE

98.5 g of a carbon dioxide-propylene oxide copolymer having a number average molecular weight of 82,000 (produced according to CN 1116332C and Chinese patent application No. 03105023.9) and 1.5 g of purified maleic anhydride, a small molecular end-capping reagent, were mixed uniformly in a high speed blender. The mixture was dried in a vacuum oven at 40° C. for 10 hours, and then put into a Haake mixer, and banbury mixed with a speed of 30 r/min at 140° C. for 3.5 min. The mixture was taken out, cut into pieces, and cooled. The initial thermal decomposition temperature was 232° C. (FIG. 4). The analysis instrument used was PerkinElmer Thermal Analyzer.

We claim:

1. A polymeric end-capping reagent for carbon dioxide-epoxide copolymers, comprising a maleic anhydride copolymer.

2. The polymeric end-capping reagent for carbon dioxide-epoxide copolymers according to claim 1, wherein the maleic anhydride copolymer is a maleic anhydride-second monomer copolymer and/or a maleic anhydride-second monomer-third monomer terpolymer.

3. The polymeric end-capping reagent for carbon dioxide-epoxide copolymers according to claim 2, wherein the maleic anhydride copolymer is at least one selected from the group consisting of maleic anhydride-methyl methacrylate copolymer, maleic anhydride-methyl acrylate copolymer, maleic anhydride-n-butyl methacrylate copolymer, maleic anhydride-n-butyl acrylate copolymer; wherein the weight ratio of maleic anhydride to the second monomer is 5-25: 75-95.

4. The polymeric end-capping reagent for carbon dioxide-epoxide copolymers according to claim 2, wherein the maleic anhydride terpolymer is at least one selected from the group consisting of maleic anhydride-n-butyl methacrylate-methyl methacrylate terpolymer, maleic anhydride-n-butyl methacrylate-methyl acrylate terpolymer, maleic anhydride-n-butyl acrylate-methyl methacrylate terpolymer, maleic anhydride-n-butyl acrylate-methyl acrylate terpolymer, maleic anhydride-isooctyl methacrylate-methyl methacrylate terpolymer, maleic anhydride-isooctyl methacrylate-methyl acrylate terpolymer, maleic anhydride-isooctyl acrylate-methyl methacrylate terpolymer, maleic anhydride-isooctyl acrylate-methyl acrylate terpolymer; wherein, the weight ratio of maleic anhydride to the second monomer to the third monomer is 2-6: 35-45: 49-63.

5. The polymeric end-capping reagent for carbon dioxide-epoxide copolymers according to claim 3, wherein the weight ratio of maleic anhydride to the second monomer is 10 to 20:80 to 90.

6. The polymeric end-capping reagent for carbon dioxide-epoxide copolymers according to claim 4, wherein the weight ratio of maleic anhydride to the second monomer to the third monomer is 3-6: 35-40: 54-62.

7. The polymeric end-capping reagent for carbon dioxide-epoxide copolymers according to claim 1, having a number average molecular weight of Mₙ=4-6×10⁴, and a distribution index of 1.5-3.0.

8. A method for preparing a polymeric end-capping reagent for carbon dioxide-epoxide copolymers, comprising the steps of:
copolymerizing maleic anhydride and other comonomer(s) in a solvent by using an initiator; and
post-processing the resultant maleic anhydride copolymer to obtain a polymeric end-capping reagent for carbon dioxide-epoxide copolymers.

9. The method according to claim 8, wherein the initiator is at least one selected from the group consisting of benzoyl peroxide, lauroyl peroxide, and azobisisobutyronitrile.

10. The method according to claim 8, wherein the other comonomer is one monomer selected from the group consisting of methyl methacrylate, methyl acrylate, n-butyl methacrylate, and n-butyl acrylate, which is a second monomer being copolymerized with maleic anhydride to produce maleic anhydride-second monomer copolymer, wherein the weight ratio of maleic anhydride to the second monomer is 5-25: 75-95.

11. The method according to claim 8, wherein the other comonomers are two different monomers selected from the group consisting of methyl methacrylate, methyl acrylate, n-butyl methacrylate, n-butyl acrylate, isooctyl methacrylate, and isooctyl acrylate, wherein the two different monomers are a second monomer and a third monomer being copolymerized with maleic anhydride to produce maleic anhydride-second monomer-third monomer terpolymer, respectively, wherein the weight ratio of maleic anhydride to the second monomer to the third monomer is 2-6: 35-45: 49-63.

12. The method according to claim 10, wherein the weight ratio of maleic anhydride to the second monomer is 10-20: 80-90.

13. The method according to claim 11, wherein the weight ratio of maleic anhydride to the second monomer to the third monomer is 3-6: 35-40: 54-62.

14. The method according to claim 8, wherein the initiator is used in an amount of 1% to 1% by weight based on the total weight of the monomers.

15. The method according to claim 8, wherein the initiator is used in an amount of 3% to 6% by weight based on the total weight of the monomers.

16. The method according to claim 8, wherein the solvent is anhydrous toluene.

17. The method according to claim 8, wherein the post-processing includes:
distilling the reaction mixture under a reduced pressure at 100 to 120° C. until no distillate drops out, and
transferring the reaction mixture into a vacuum oven and drying till a constant weight, thus obtaining the polymeric end-capping reagent.
